(19) United States
(12) Patent Application Publication
(10) Pub. No.: US 2021/0162772 A1
(43) Pub. Date: Jun. 3, 2021

(54) IMAGE FORMATION WITH ELECTROSTATIC FIXATION

(71) Applicant: Hewlett-Packard Development Company, L.P., Spring, TX (US)

(72) Inventors: Omer Gila, Palo Alto, CA (US); Napoleon J Leoni, Palo Alto, CA (US)

(73) Assignee: Hewlett-Packard Development Company, L.P., Spring, TX (US)

(21) Appl. No.: 17/047,351

(22) PCT Filed: Aug. 14, 2018
(86) PCT No.: PCT/US2018/046708

§ 371 Date: Oct. 13, 2020

(51) Int. Cl. B41J 2/41; B41J 11/00

(52) U.S. Cl. CPC B41J 2/41; B41J 11/0022; B41J 11/0021

(57) ABSTRACT

A device includes a media supply, a first portion, and a second portion. The media supply is to supply a media along a travel path and to which a ground element is to be electrically connected. The first portion along the travel path is to receive droplets of ink particles within a dielectric carrier fluid on the media to form at least a portion of an image on the media. The second portion is downstream along the travel path from the first portion and includes a charge generation portion to emit airborne charges to charge the ink particles to move, via attraction relative to the grounded media, through the received carrier fluid toward the media to become electrostatically fixed on the media.

### BACKGROUND

Modern printing techniques involve a wide variety of media, whether rigid or flexible, and for a wide range of purposes.

### BRIEF DESCRIPTION OF THE DRAWINGS

FIG. 1A is a diagram including a side view schematically representing an example image formation device and/or method of image formation.

FIG. 1B is a diagram including a side view schematically representing an example receiving portion for a fluid ejection device.

FIG. 1C is a diagram including a side view schematically representing an example fluid ejection device removably inserted relative to an example receiving portion for a fluid ejection device.

FIG. 2 is a diagram including a side view schematically representing an example image formation device.

FIG. 3A is a block diagram schematically representing an example first liquid removal portion.

FIG. 3B is a block diagram schematically representing an example second liquid removal portion.

FIG. 4 is a diagram including a side view schematically representing an example image formation device.

FIG. 5 is a diagram including a side view schematically representing an example image formation device and/or method of image formation.

FIGS. 6A-6B are a series of diagrams schematically representing example image formation on a media.

FIGS. 7A and 7B are a block diagram schematically representing an example control portion and an example user interface, respectively.

FIG. 8 is a flow diagram schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

In some examples, an image formation device comprises a media supply, a first portion, and a second portion. The media supply is to supply a media along a travel path and to which a ground element is to be electrically connected. The first portion along the travel path is to receive droplets of ink particles within a dielectric carrier fluid onto the media to form at least a portion of an image on the media. The second portion is downstream along the travel path from the first portion and includes a charge generation portion to emit airborne charges to charge the ink particles to move, via attraction relative to the grounded media, through the carrier fluid toward the media to become electrostatically fixed on the media.

In some examples, the image formation device may sometimes be referred to as a printer or printing device. In some examples in which a media is supplied in a roll-to-roll arrangement or similar arrangements, the image formation device may sometimes be referred to as a web press and/or the media can be referred to as a media web.

At least some examples of the present disclosure are directed to forming an image directly on a media, such as without an intermediate transfer member. Accordingly, in some instances, the image formation may sometimes be referred to as occurring directly on the media. However, this does not necessarily exclude some examples in which an additive layer may be placed on the media prior to receiving ink particles (within a carrier fluid) onto the media. In some instances, the media also may sometimes be referred to as a non-transfer media to indicate that the media itself does not comprise a transfer member (e.g. transfer blanket, transfer drum) by which an ink image is to be later transferred to another media (e.g. paper or other material). In this regard, the media may sometimes also be referred to as a final media or a media product. In some such instances, the media may sometimes be referred to as product packaging media.

In some examples, the non-transfer media may sometimes be referred to as a non-transfer substrate, i.e. a substrate which does not act as a transfer member (e.g. a member by which ink is initially received and later transferred to a final substrate bearing an image).

In some examples, the media comprises a non-absorbing media. Stated differently, in some examples the media is made of a material which does not absorb liquids, such as a carrier fluid and/or other liquids in the droplets received on the media. In one aspect, in some such examples the non-absorbing media does not permit the liquids to penetrate, or does not permit significant penetration of the liquids, into the surface of the non-absorbing media.

Via the example arrangements, the example device and/or associated methods can print images on a non-absorbing media (or some other media) with minimal bleeding, dot smearing, etc. while permitting high quality color on color printing. Moreover, via these examples, image formation on a non-absorbing media (or some other media) can be performed with less time, less space, and less energy at least due to a significant reduction in drying time and capacity. These example arrangements stand in sharp contrast to other printing techniques, such as high coverage, aqueous-based step inkjet printing onto non-absorbing media for which bleeding, dot smearing, cockling, etc. may yield relatively lower quality results, as well as unacceptably high cost, longer times, etc. associated with drying.

In some examples, the first portion of the image formation device comprises a receiving portion to receive a fluid ejection device with the fluid ejection device to deliver the droplets of ink particles within the dielectric carrier fluid on the non-transfer media to form at least a portion of an image on the media.

In some examples, the fluid ejection device may comprise a drop-on-demand fluid ejection device to eject the droplets of ink particles (within the carrier fluid) onto the media. In some examples, the fluid ejection device comprises an inkjet printhead. In some examples, the inkjet printhead comprises a piezoelectric inkjet printhead. In some examples, the inkjet may comprise a thermal inkjet printhead. In some examples, the droplets may sometimes be referred to as being jetted onto the media. With this in mind, example image formation according to at least some examples of the present disclosure may sometimes be referred to as “jet-on-media” or “jet-on-substrate.”

In some examples, the fluid ejection device is to eject/deposit the dielectric carrier fluid on the media as a non-aqueous fluid. In some examples, the non-aqueous fluid comprises an isoparrafinic fluid or other oil-based liquid suitable for use as a dielectric carrier fluid.

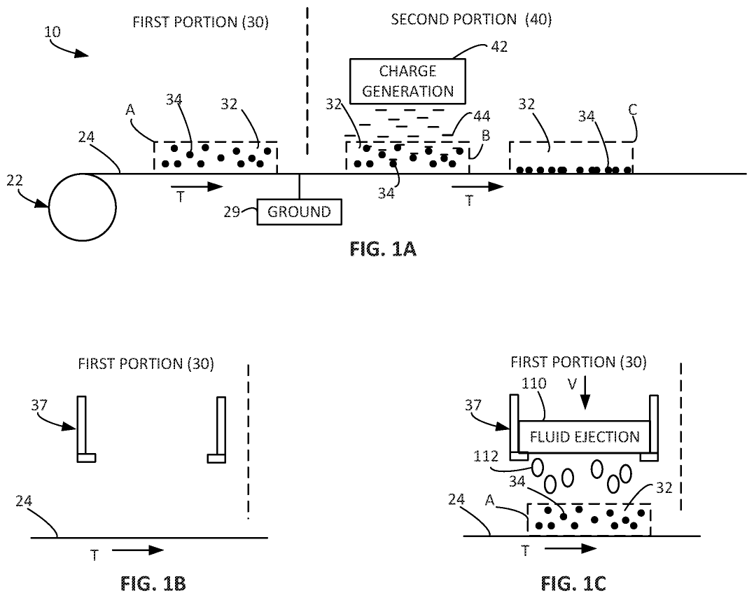

These examples, and additional examples, will be further described below in association with at least FIGS. 1-8.

FIG. 1A is a diagram including a side view schematically representing an example image formation device 10. It will be further understood that FIG. 1A also may be viewed as schematically representing at least some aspects of an example method of image formation.

As shown in FIG. 1A, in some examples an image formation device 10 comprises a media supply 22, a first portion 30, and a second portion 40. The media supply 22 is to supply a media 24 along a travel path T and to which a ground element 29 is to be electrically connected. In some examples, media supply 22 may comprise a roll of media which is fed and moved along travel path T via support from an array of rollers to maintain tension and provide direction to media along travel path T.

In some examples, media 24 comprises a metallized layer or foil to which a ground element 29 is electrically connected. In some examples, an electrically conductive element separate from the media 24 is provided to contact the media 24 in order to implement grounding of the media 24.

As shown in FIG. 1A, in some examples the first portion 30 of image formation device 10 is located along and/or forms a portion of the travel path T, and is to receive droplets of ink particles 34 within a dielectric carrier fluid 32 on the media 24. The depiction within the dashed lines A in FIG. 1A represents ink particles 34 and carrier fluid 32 after being received on media 24 to form at least a portion of an image on the media 24. In some examples, the droplets from which ink particles 34 are formed may comprise pigments, dispersants, the carrier fluid 32, and may comprise additives such as bonding polymers.

As further shown in FIG. 1A, in some examples, the second portion 40 of image formation device 10 is located downstream along the travel path T from the first portion 30 and includes a charge generation portion 42 to emit airborne charges 44 to charge the ink particles 34, as represented via the depiction in dashed lines B in FIG. 1A. Once charged, the ink particles 34 move, via attraction relative to the grounded media 24, through the carrier fluid 32 toward the media 24 to become electrostatically fixed on the media 24, as represented via the depiction in dashed lines C in FIG. 1A.

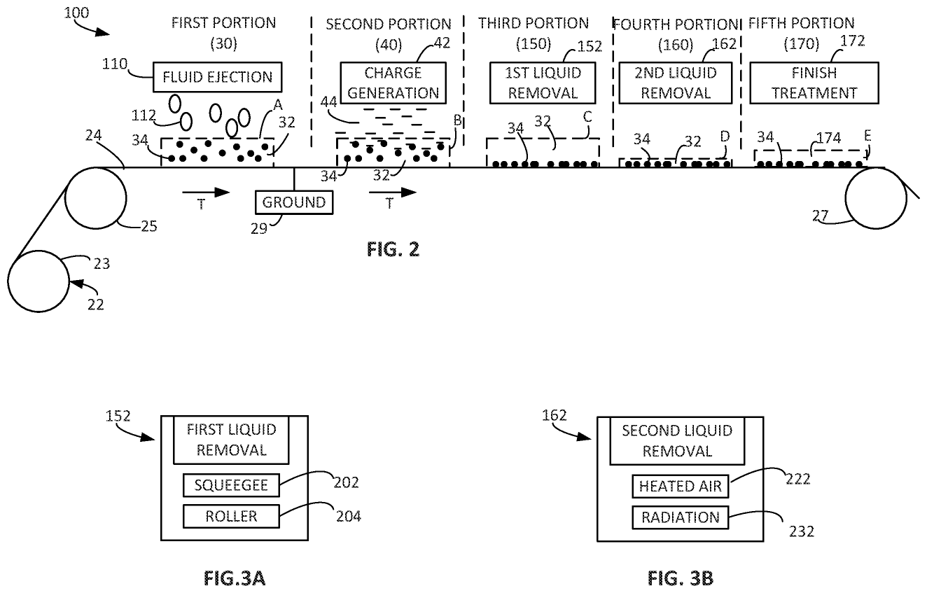

In some examples, the first portion 30 of image formation device 10 comprises a fluid ejection device to eject the droplets of ink particles 32 within the carrier fluid 32. FIG. 2 provides an illustration of one such example fluid ejection device 110, which is positionable at a location spaced apart and above the media 24. In some examples, the fluid ejection device 110 comprises a drop-on-demand fluid ejection device. In some examples, the drop-on-demand fluid ejection device comprises an inkjet printhead. In some examples, the inkjet printhead comprises a piezoelectric inkjet printhead. In some examples, the fluid ejection device 100 may comprise other types of inkjet printheads.

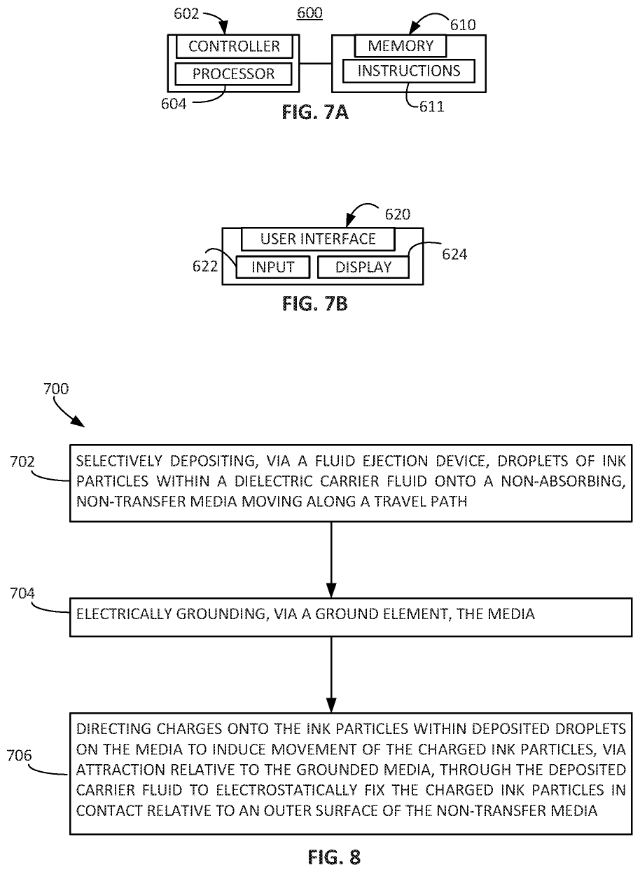

In some examples, as further described later in association with at least FIG. 7A, among directing other and/or additional operations, a control portion 600 is instruct or to cause the fluid ejection device 110 to deliver the droplets of ink particles 34 within the dielectric carrier fluid 32 onto the media 24, such as within the first portion along the travel path T of the media 24.

As further shown in FIG. 1B, in some examples the first portion 30 of image formation device 10 may comprise a first receiving portion 37 to removably receive the fluid ejection device 110, such as in some examples in which the fluid ejection device 110 is removably insertable into the first receiving portion 37. The first receiving portion 37 is sized, shaped, and positioned relative to media 24, as well as relative to other components of image formation device 10, such that upon removable insertion relative to first receiving portion 37 (as represented by arrow V), the fluid ejection device 110 is positioned to deliver (e.g. eject) the droplets of ink particles 34 and dielectric carrier fluid 32 onto media 24, as shown in FIG. 1C. In some such examples, the fluid ejection device 110 may comprise a consumable which is periodically replaceable due to wear, exhaustion of an ink supply, etc. In some such examples, the fluid ejection device 110 may be sold, supplied, shipped, etc. separately from the rest of image formation device 10 and then installed into the image formation device 10 upon preparation for use of image formation device 10 at a particular location. The first receiving portion 37 may sometimes be referred to as a first receptor.

With further reference to at least FIGS. 1A, 1C, and 2A, in some examples, as part of ejecting droplets (e.g. 112 in FIG. 2), the fluid ejection device 110 is to deposit the dielectric carrier fluid 32 on the media 24 as a non-aqueous liquid. In some examples, the non-aqueous liquid comprises an isoparrafinic fluid, which may be sold under the trade name ISOPAR. In some such examples, the non-aqueous liquid may comprise other oil-based liquids suitable for use as a dielectric carrier fluid.

With further reference to FIG. 1A, in some examples the charge generation device 42 in the second portion 40 may comprise a corona, plasma element, or other charge generating element to generate a flow of charges. The generated charges may be negative or positive as desired. In some examples, the charge generation device 42 may comprise an ion head to produce a flow of ions as the charges. It will be understood that the term “charges” and the term “ions” may be used interchangeably to the extent that the respective “charges” or “ions” embody a negative charge or positive charge (as determined by device 42) which can become attached to the ink particles 34 to cause all of the charged ink particles to have a particular polarity, which will be attracted to ground. In some such examples, all or substantially all of the charged ink particles 34 will have a negative charge or alternatively all or substantially all of the charged ink particles 34 will have a positive charge.

Via such example arrangements, the charged ink particles 34 become electrostatically fixed on the media 24 in a location on the media 24 generally corresponding to the location (in an x-y orientation) at which they were initially received onto the media 24 in the first portion 30 of the image formation device 10. Via such electrostatic fixation, the ink particles 34 will retain their position on media 24 even when other ink particles (e.g. different colors) are added later, excess liquid is physically removed, etc. It will be understood that while the ink particles may retain their position on media 24, some amount of expansion of a dot (formed of ink particles) may occur after the ink particles 34 (within carrier fluid 32) are jetted onto media 24 and before they are electrostatically pinned. In some examples, the charge generation device 42 is spaced apart by a predetermined distance (e.g. downstream) from the location at which the droplets are received (or ejected) in order to delay the electrostatic fixation (per operation of charge generation device 42), which can increase a dot size on media 24, which in turn may lower ink consumption.

In some examples, the ground element 29 may comprise an electrically conductive element in contact with a portion of the media 24. In some examples, the electrically conductive element may comprise a roller or plate in rolling or slidable contact, respectively, with a portion of the media. In some examples, the ground element 29 is in contact with an edge or end of the media. In some examples, the electrically conductive element may take other forms, such as a brush or other structures. Accordingly, it will be understood that the ground element 29 is not limited to the particular location shown in FIG. 1A.

In some examples, the media supply 22 of image formation device 10 is to supply the media 24 as a non-absorbing media. Stated differently, the media 24 is made of a material and/or coatings which hinder or prevent absorption of liquid, which stands in sharp contrast to some forms of media, such as paper, which may absorb liquid. The non-absorbing attributes of the media 24 may facilitate drying of the ink particles on the media at least because later removal of liquid from the media will not involve the time and expense of attempting to pull liquid out of the media (as occurs with absorbing media) and/or the time, space, and expense of providing heated air for extended periods of time to dry liquid in an absorptive media.

In some such examples, the non-absorptive media 24 may comprise other attributes, such as acting as a protective layer for items packaged within the media. Such items may comprise food or other sensitive items for which protection from moisture, light, air, etc. may be desired.

With this in mind, in some examples the media 24 may comprise a plastic media. In some examples, the media 24 may comprise polyethylene (PET) material, which may comprise a thickness on the order of about 10 microns. In some examples, the media 24 may comprise a biaxially oriented polypropylene (BOPP) material. In some examples, the media 24 may comprise a biaxially oriented polyethylene terephthalate (BOPET) polyester film, which may be sold under trade name Mylar in some instances. In some examples, the media 24 may comprise other types of materials which provide at least some of the features and attributes as described throughout the examples of the present disclosure. For examples, the media 24 or portions of media 24 may comprise a metallized foil or foil material, among other types of materials.

FIG. 2 is a diagram including a side view schematically representing an example image formation device 100. In some examples, device 100 comprises at least some of substantially the same features and attributes as device 10 previously described in association with FIG. 1A. It will be further understood that FIG. 2 also may be viewed as schematically representing at least some aspects of an example method of image formation.

As shown in FIG. 2, the image formation device 100 comprises a media supply 22, first portion 30, and second portion 40 having substantially the same features and attributes as in device 10 in FIG. 1A. In some examples, fluid ejection device 110 in the first portion 30 may comprise a permanent component of image formation device 10, which is sold, shipped, and/or supplied, etc. as part of image formation device 10. It will be understood that such “permanent” components may be removed for repair, upgrade, etc. as appropriate.

However, in some examples, first portion 30 may comprise a first receiving portion 37 as shown in FIG. 1B to removably receive fluid ejection device 110, as previously described in association with FIGS. 1B-1C, such as in instances when fluid ejection device 110 may comprise a consumable, be separately sold, etc.

However, as shown in FIG. 2, in some examples image formation device 100 comprises a third portion 150, including a first liquid removal portion 152, downstream along the travel path T from the charge generation portion 42 (in second portion 40) to remove at least a portion of the carrier fluid 32 from the media 24. In some examples, the first liquid removal portion 152 is to remove the carrier fluid 32 without heating the fluid 32 at all or without heating the carrier fluid 32 above a predetermined threshold. In some instances, such liquid removal may sometimes be referred to as cold liquid removal by which the liquid is removed at relatively cool temperatures, at least as compared to high heat drying techniques. Accordingly, in some such examples, a mechanical element (e.g. squeegee roller) of the first liquid removal portion 152 may slightly heat the carrier fluid 32 and/or other liquid without using heat as a primary mechanism to remove the carrier fluid 32 from the ink particles 34 on media 24.

As further shown in FIG. 3A, the first liquid removal portion 152 may comprise a squeegee 202 and/or roller 204 or other mechanical structure to remove the carrier fluid 32 (and any other liquid) from the surface of media 24. In some examples, the electrostatically fixed (e.g. pinned) charged ink particles 34 remain fixed in their respective locations on media 24 during this physical removal of liquid at least because the electrostatic fixation forces are greater than the shear forces exhibited via the tool(s) used to mechanically remove the carrier fluid 32. In this third portion 150, in some examples, at least 80 percent of the jetted carrier fluid 32 on media 24 is removed. In some examples, at least 90 percent of the jetted carrier fluid 32 is removed. In some examples, at least 95 percent of the jetted carrier fluid 32 is removed. However, in some examples, first liquid removal portion 152 may remove at least 50 percent of total liquid, which includes the carrier fluid 32, from media 24.

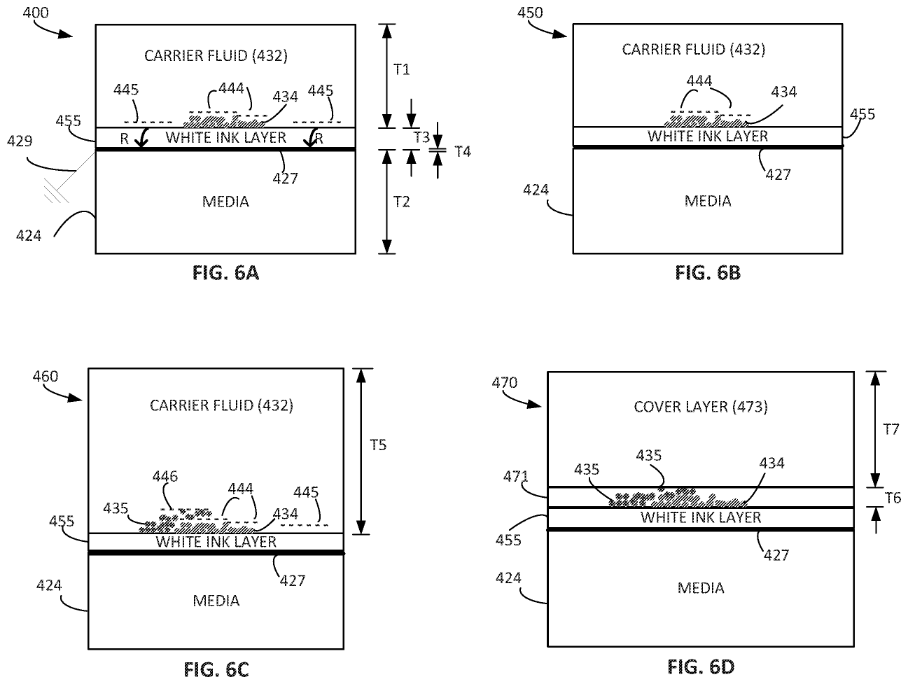

As further shown in FIG. 2, in some examples the device 100 may further comprise a second liquid removal portion 162 (in fourth portion 160) downstream from the first liquid removal portion 152. The second liquid removal portion 162 acts to remove any liquid not removed via first liquid removal portion 152 (in third portion 150) and thereby result in dried ink particles 34 on the media 24, as represented via the depictions in dashed lines D and E in FIG. 2, or as later shown in FIG. 6D.

As later shown in FIG. 3B, in some examples the second liquid removal portion 162 may comprise a heated air element 222 to direct heated air onto at least the carrier fluid 32 and media 24. In some examples, the heated air is controlled to maintain the ink particles 34, media 24, etc. at a temperature below 60 degrees C., which may prevent deformation of media 24 such as cockling, etc.

In some examples, the second liquid removal portion 162 may comprise a radiation element 232 to direct at least one of infrared (IR) radiation and ultraviolet (UV) radiation onto the liquid 32 and media 24 to eliminate liquid remaining after operation of the first liquid removal portion 152. In some examples, the second liquid removal portion 162 may sometimes be referred to as an energy transfer mechanism or structure by which energy is transferred to the liquid 32, ink particles 34, and media 24 in order to dry the ink particles 34 and/or media 24.

As further shown in FIG. 2, in some examples image formation device 100 may further comprise a finish treatment element 172 (in fifth portion 170) downstream from the second liquid removal portion 162 (in fourth portion 160) to add a finish layer 174 on top of the ink particles 34 electrostatically fixed on the media 24. The finish layer 174 may enhance adhesion of the ink particles 34 to the media 24, protect the image formed by the ink particles 34, etc. The material applied as a finish layer 174 may be ultraviolet curable, a solvent, water-based, etc. In some examples, the material applied as a finish layer 174 may be a sealant, adhesion promoter, varnish, and the like, as well as various combinations of such finishing materials. In some examples, the finish layer may be implemented as later described in association with at least FIG. 6D.

In some examples, the finish layer 174 is added via finish treatment element 172 prior to operation of the second liquid removal portion 160. Accordingly, it will be understood that in some examples, the sequence of operation of some portions (e.g. 150, 160, 170) of image formation device 10 may be re-arranged in some instances. Moreover, it will be understood that in some examples the labeling of the various portions as first, second, third, fourth, fifth portions (e.g. 30, 40, 150, 160, 170) does not necessarily reflect an absolute ordering or position of the respective portions along the travel path T. Moreover, such labeling of different portions also does not necessarily represent the existence of structural barriers or separation elements between adjacent portions of the image formation device 10, 100. Furthermore, in some examples, the components of the image formation device 100 may be organized into a fewer or greater number of portions than represented in FIG. 2.

As further shown in FIG. 2, in some examples media supply 22 may comprise a plurality of rollers 23, 25, 27 to support and guide media 24 along travel path T. While not shown for illustrative simplicity, additional rollers may be present to support media 24 throughout each of the different portions of an image formation device. In some examples, these arrangements of rollers may comprise a roll-to-roll arrangement.

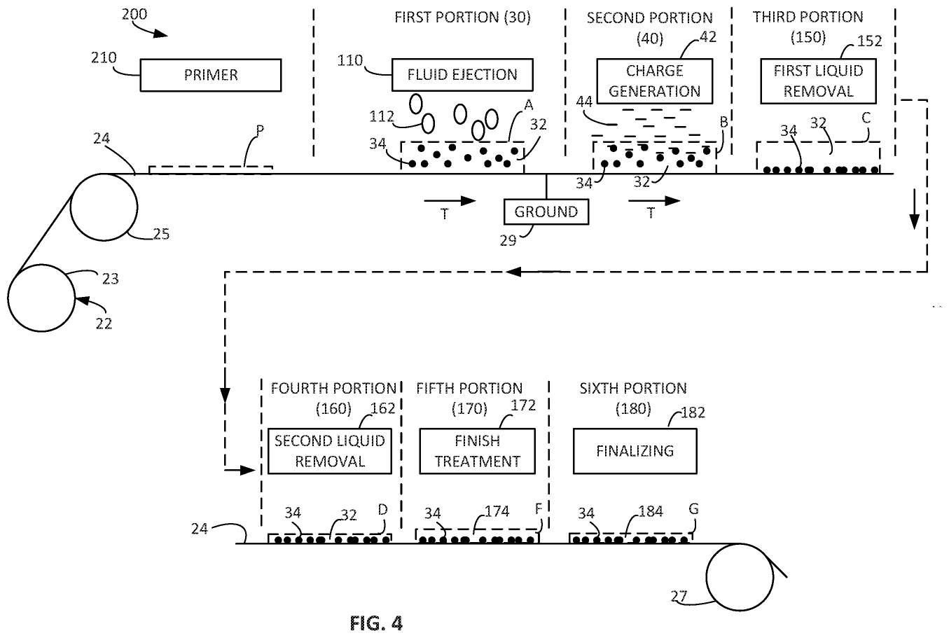

FIG. 4 is a diagram including a side view schematically representing an example image formation device 200. In some examples, the example image formation device 200 comprises at least some of substantially the same features as the example image formation devices 10 (FIG. 1A), 10 (FIGS. 1B-1C), and/or 100 (FIGS. 2, 3A-3B) with similar reference numerals denoting similar elements.

In some examples, example image formation device 200 comprises additional elements such as an example primer element 210 and/or a finalizing element 182 in a sixth portion 180. It will be further understood that FIG. 4 also may be viewed as schematically representing at least some aspects of an example method of image formation.

As shown in FIG. 4, the primer element 212 forms part of a preliminary portion 210 (e.g. seventh portion) which is upstream from (e.g. precedes) the first portion 30 and which is provided to deposit a primer layer (represented via dashed box P). In some examples, the primer layer comprises material(s) which prepare the surface of media 24 to receive droplets of ink particles 34 within the carrier fluid 32 in the first portion 30. Some example primer materials may comprise a resin, dissolved resin, binding polymers, or adhesion promoting materials.

As further shown in FIG. 4, the example finalizing element 182 in sixth portion 180 of image formation device 200 is downstream from the finish treatment element 172 (in fifth portion 170) of image formation device 200. In some examples, the finalizing element 182 may provide heated air, ultraviolet (UV) radiation, infrared (IR) radiation, or similar modalities. Via at least such modalities, the finalizing element 182 may act to remove liquid from the ink particles 34 (and/or from media 24) and/or may act to induce or cause curing of the finishing layer 174 added via the finish treatment element 172 in the fifth portion 170.

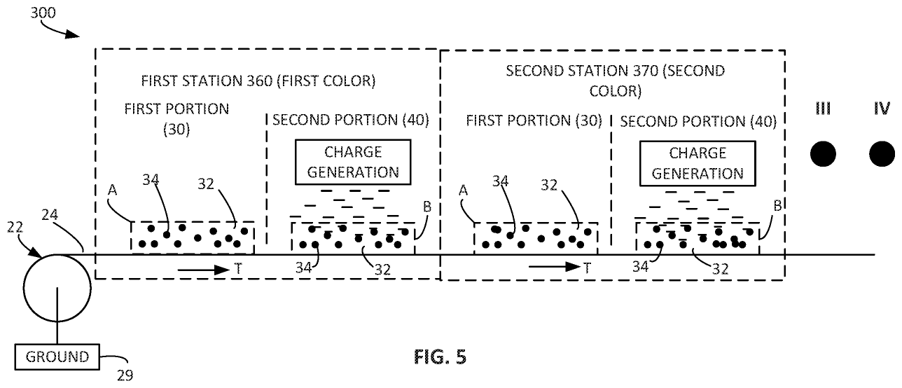

FIG. 5 is a diagram including a side view schematically representing an example image formation device 300. In some examples, the image formation device 300 comprises a media supply and a series of stations arranged along the travel path of the media in which each station is to provide one color ink of a plurality of different color inks onto the media. It will be further understood that FIG. 5 also may be viewed as schematically representing at least some aspects of an example method of image formation.

In some examples, the image formation device 300 comprises at least some of substantially the same features and attributes as the devices 100, 200, etc., and portions, components, thereof, as previously described in association with FIGS. 1A-4. However, in image formation device 300 a series of image formation stations 360, 370, etc. is provided along a travel path of the media 24. In some examples, each different image formation station 360, 370, etc. provides for at least partial formation of an image on media 24 by a respectively different color ink. Stated differently, the different stations apply different color inks such that a composite of the differently colored applied inks forms a complete image on media 24 as desired. In some examples, the different color inks correspond to the different colors of a color separation scheme, such as Cyan (C), Magenta (M), Yellow (Y), and black (K) wherein each different color is applied separately as a layer to the media 24 as media 24 moves along travel path T.

As shown in FIG. 5, each station 360, 370, etc. may comprise at least a first portion 30 and a second portion 40 having substantially the same features as previously described. In some examples, each station may comprise additional portions, such as but not limited to, portions 150, 160, 170 as described in association with at least FIG. 2.

As further shown in FIG. 5, the image formation device 300 may comprise additional stations, and as such, the black circles III, IV represent further stations like stations 360, 370 for applying additional different color inks onto media 24. In some examples, the additional stations may comprise a fewer number or a greater number of additional stations (e.g. III, IV) than shown in FIG. 5.

FIGS. 6A-6B are a series of diagrams, each including a side view, schematically representing some aspects of example image formation on a media 424 in association with an example image formation device and/or an example method of image formation. In some examples, the image formation may be implemented via one of the example devices 100, 200, etc. and/or methods, as previously described in association with at least FIGS. 1A-5 and/or via method 500 in association with FIG. 8.

In one such example, the diagram 400 in FIG. 6A schematically represents a state of a media 424 after passage through the second portion 40 of an image formation device (e.g. FIGS. 1A-2B), but prior to passage along the travel path T through a third or fourth portions (e.g. 150, 160) for liquid removal. As such, FIG. 6A depicts charged particles 434 as electrostatically fixed on media 424 with charges 444 remaining on/with the ink particles 434 and with carrier fluid 432 still present on media 424. As further shown in FIG. 6A, extra charges 445 are present on a surface of a white ink layer 455 in areas in which no ink particles are present. Discharge of these charges 445 is further described later with respect to the role of white ink layer 455.

In some examples, media 424 comprises a flexible packaging material. In some such examples, the flexible packaging material may comprise a food packaging material, such as for forming a wrapper, bag, sheet, cover, etc. As previously mentioned for at least some examples, the flexible packaging materials may comprise a non-absorptive media.

In at least some examples associated with FIGS. 6A-6D, the media 24 comprises a generally uniform white ink layer 455 which is present prior to applying the different color inks to form the intended image on the media 424. Among other features and attributes, the white color of ink layer 455 provides a suitable neutral background against which images may be formed on media 424, thereby enhancing clarity, sharpness, etc. of the image. In some examples, the ink layer 455 may comprise a color other than white but which is suitable in providing a generally uniform background appearance on media 424.

In some such examples, a media supply (e.g. 22 in FIGS. 1A-2B, 5) is to supply the media 424 already having the white ink layer 455 and onto which the ink particles 434 (e.g. 34 in FIGS. 1A-5) are to be electrostatically fixed.

However, in some examples, the media 424 may initially omit a white ink layer 455 and instead, the white ink layer 455 is added via a first portion (e.g. 20) of a first station via a fluid ejection device (e.g. 110 in FIG. 2) and then other color ink layers are added to the media 424 via subsequent image formation stations, such as shown in at least FIG. 5. In some such examples, the white color ink comprising the layer 455 may sometimes be implemented as a SPOT color ink.

As represented via directional arrows R shown in FIG. 6A, the white ink layer 455 may also facilitate discharge of background charges 445 (to ground 29 via layer 455), i.e. those charges emitted by charge generation portion 162 which do not become bound to an ink particle 34, 434 or which are otherwise not dissipated. In some examples, the white ink layer 455 may comprise a conductivity below 10¹⁰ Ohm CM, which is suitable to allow discharge of background charges to ground, thereby enabling electrostatic fixation of a second color ink particles 435 shown in FIGS. 6C, 6D.

Via the absence of charges 445 at the surface of white ink layer 455, the diagram 450 in FIG. 6B depicts the discharge of the background charges 455 initially present from charging ink particles 434 as shown in FIG. 6A.

In one aspect, the electrical properties (e.g. conductivity and dielectric thickness) of the white ink layer 455 may be tuned to allow electrostatic fixation of the ink particles 434 for a long enough period of time (e.g. on the order of 100 milliseconds) to effectuate the electrostatic fixation while still being quick enough to avoid building a voltage that would be too high so as to interfere with electrostatic fixation of the next color ink in forming an image on media 424.

As further shown in FIG. 6A, in some examples the media 424 may have a thickness T2 on the order of 10 microns (e.g. PET), 20 microns (e.g. BOPP) while the white ink layer 455 may comprise a thickness T3 on the order of a few microns, such as about 1 to 10 microns. FIG. 6A also illustrates that, upon initially receiving droplets from a fluid ejection device (e.g. 110 in FIG. 2) onto media 424 (and white ink layer 455), an appreciable volume of carrier fluid 432 (with ink particles 434 therein) accumulates. In some such examples, a thickness T1 of the carrier fluid 432 for one such layer may be on the order of 10 microns, while the accumulated carrier fluid 432 for multiple layers (e.g. 3) may be on the order of about 30 microns. As shown later in the diagram 460 in FIG. 6C, the accumulation of carrier fluid 432 for two layers of color ink being received on media 424 may be represented as a thickness T5, which may be on the order of about 20 microns.

As further shown in FIG. 6A, in some examples a metallic layer 427 may serve as an outer layer (e.g. upper layer) of media 424, and may comprise a thickness T4 on the order of tens of nanometers and up to a few microns. In some examples, the metallic layer 427 may form part of media 424 when media 424 comprises a flexible product packaging used to protect food or other sensitive contents. The metallic layer 427 may act as a moisture and oxygen barrier to protect the safety and freshness of the food or to protect other attributes of sensitive non-food contents.

As further shown in FIG. 6A, a ground element 429 is electrically connected to the metallic layer 427 of media 424 to ground media 424 to attract charged ink particles 434. As previously mentioned in association with at least FIGS. 1A-2B, other portions of media 424 may provide an electrically conductive element to which ground element 429 may be electrically connected.

In some examples, after the pigments (e.g. ink particles 434) are separated and electrostatically fixed (e.g. pinned), chemical forces may develop to further facilitate the fixation of ink particles 434 to media 424 (via white ink layer 455). In one aspect, the existence of and/or strength of such chemical forces depend on at least the pigment type, pigment coating, polymers/additives to the ink, etc.

FIG. 6C illustrates another point in time during formation of an image on media 424, such as after droplets of ink particles 435 of a second color ink (within some carrier fluid 432) have been jetted onto the media 424 (on white ink layer 455), and after charges have been applied via a charge generation device (e.g. 42 in FIGS. 1A-2B, 5) to the second color ink particles 435. As shown in FIG. 6C, some of the second color ink particles 435 cover, overlap, and/or intermix with some of the first color ink particles 434. In a manner similar to FIG. 6A, it can be seen in FIG. 6C that background charges 445 are present but may be discharged in a manner similar to that described in association with FIGS. 6A-6B.

Moreover, the view in FIG. 6C also depicts a greater thickness (T5) of carrier fluid 432 on top of the white ink layer 455 and media 424, which corresponds to the additional carrier fluid 432 in which the second color ink particles 435 were delivered when jetted onto white ink layer 455 and media 424.

While not directly represented in FIGS. 6A-6D, it will be understood that after all the different color ink particles are deposited on white ink layer 455 to form a desired image on media 424, excess carrier fluid 432 is removed mechanically (e.g. via first liquid removal portion 152) and via application of energy (e.g. via second liquid removal portion 162), such as shown in at least FIGS. 2-4.

With this in mind, as shown in the diagram in FIG. 6D, after the removal of liquid (e.g. carrier fluid 432) and drying, a finish layer 471 is applied on top of the dried, ink particles 434, 435, etc. (in the form of an image) and a cover layer 473 of a protective material (e.g. Mylar, PET, etc.) is laminated or otherwise secured onto the finish layer 471. In one example, once sealed the completed assembly 470 may be used in the flexible packaging market. In some examples, such flexible packaging may comprise food packaging. In some such examples of food packaging, the media layer 424 of completed assembly 470 may face or enclose the food contained with the package formed from completed assembly 470. Meanwhile, the cover layer 472 may face or be exposed to the consumer, user, etc.

In some such examples, this additional outer cover layer 473 can be transparent. In some examples, the finish layer 471 comprises an adhesive to facilitate securing the cover layer 473.

However, with further reference to at least FIG. 6D, in some examples the finish layer 471 may be applied on top of the dried, ink particles 434, 435 without adding cover layer 473 such that finish layer 471 acts as a protective element for ink particles 434, 435. In some examples, the finish layer 471 may comprise a sealant, adhesive, varnish, and the like, such as but not limited to at least some of substantially the same features and attributes as the finish layer(s) provided via finish treatment element 172, as previously described in association with at least FIGS. 2 and 4. In some examples, the finish layer 471 is finalized via curing (e.g. UV, IR) or heated air in order to dry, fix, cross-link, and/or solidify the finish layer 471 with the ink particles 434, 435 on media 424. In some examples, such finalizing may be performed via a finalizing element 182, such as described in association with FIG. 4.

In some examples, the finish layer 471 comprises a thickness T6 while the cover layer 473 comprises a thickness T7.

In some examples, the finish layer 471 comprises the final or outermost layer of a print medium, which may be available to consumers or other users and/or which is suitable for contact with handling rollers, other media, etc. However, in some examples, the presence of the finish layer 471 does not preclude the deposition of additional layers and/or other treatments.

FIG. 7A is a block diagram schematically representing an example control portion 600. In some examples, control portion 600 provides one example implementation of a control portion forming a part of, implementing, and/or generally managing the example image formation devices 10, 100, 200, as well as the particular portions, elements, devices, user interface, instructions, engines, and/or methods, as described throughout examples of the present disclosure in association with FIGS. 1A-6D and 8.

In some examples, control portion 600 includes a controller 602 and a memory 610. In general terms, controller 602 of control portion 600 comprises at least one processor 604 and associated memories. The controller 602 is electrically couplable to, and in communication with, memory 610 to generate control signals to direct operation of at least some the image formation devices, various portions and elements of the image formation devices, fluid ejection devices, charge generation elements, liquid removal portions, finishing treatment elements, user interfaces, instructions, engines, functions, and/or methods, as described throughout examples of the present disclosure. In some examples, these generated control signals include, but are not limited to, employing instructions 611 stored in memory 610 to at least direct and manage depositing droplets of ink particles and carrier fluid to form an image on a media, directing charges onto ink particles, removing liquids, applying finish treatments, etc. as described throughout the examples of the present disclosure in association with FIGS. 1-6D and 8. In some instances, the controller 602 or control portion 600 may sometimes be referred to as being programmed to perform the above-identified actions, functions, etc. In some examples, at least some of the stored instructions 611 are implemented as a, or may be referred to as, a print engine.

In response to or based upon commands received via a user interface (e.g. user interface 620 in FIG. 7B) and/or via machine readable instructions, controller 602 generates control signals as described above in accordance with at least some of the examples of the present disclosure. In some examples, controller 602 is embodied in a general purpose computing device while in some examples, controller 602 is incorporated into or associated with at least some of the image formation devices, portions or elements along the travel path, fluid ejection devices, charge generation elements, liquid removal portions, finish treatment elements, user interfaces, instructions, engines, functions, and/or methods, etc. as described throughout examples of the present disclosure.

For purposes of this application, in reference to the controller 602, the term “processor” shall mean a presently developed or future developed processor (or processing resources) that executes sequences of machine readable instructions contained in a memory. In some examples, execution of the sequences of machine readable instructions, such as those provided via memory 610 of control portion 600 cause the processor to perform the above-identified actions, such as operating controller 602 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 610. In some examples, memory 610 comprises a computer readable tangible medium providing non-volatile storage of the machine readable instructions executable by a process of controller 602. In other examples, hard wired circuitry may be used in place of or in combination with machine readable instructions to implement the functions described. For example, controller 602 may be embodied as part of at least one application-specific integrated circuit (ASIC). In at least some examples, the controller 602 is not limited to any specific combination of hardware circuitry and machine readable instructions, nor limited to any particular source for the machine readable instructions executed by the controller 602.

In some examples, control portion 600 may be entirely implemented within or by a stand-alone device.

In some examples, the control portion 600 may be partially implemented in one of the image formation devices and partially implemented in a computing resource separate from, and independent of, the image formation devices but in communication with the image formation devices. For instance, in some examples control portion 600 may be implemented via a server accessible via the cloud and/or other network pathways. In some examples, the control portion 600 may be distributed or apportioned among multiple devices or resources such as among a server, an image formation device, and/or a user interface.

In some examples, control portion 600 includes, and/or is in communication with, a user interface 620 as shown in FIG. 7B. In some examples, user interface 620 comprises a user interface or other display that provides for the simultaneous display, activation, and/or operation of at least some of the image formation devices, portions, elements, user interfaces, instructions, engines, functions, and/or methods, etc. as described in association with FIGS. 1-6D and 8. In some examples, at least some portions or aspects of the user interface 620 are provided via a graphical user interface (GUI), and may comprise a display 624 and input 622.

FIG. 8 is a flow diagram schematically representing an example method. In some examples, method 700 may be performed via at least some of the same or substantially the same devices, portions, stations, elements, control portion, user interface, etc. as previously described in association with FIGS. 1A-7B. In some examples, method 500 may be performed via at least some devices, portions, stations, elements, control portion, user interface, etc. other than those previously described in association with FIGS. 1A-7B.

In some examples, as shown at 702 in FIG. 8, method 700 comprises selectively depositing, via a fluid ejection device, droplets of ink particles within a dielectric carrier fluid onto a non-absorbing, non-transfer media moving along a travel path. As shown in FIG. 8 at 704, in some examples method 700 comprises electrically grounding, via a ground element, the media. As shown in FIG. 8 at 706, in some examples method 700 comprises directing charges onto the ink particles within deposited droplets on the media to induce movement of the charged ink particles, via attraction relative to the grounded media, through the deposited carrier fluid to electrostatically fix the charged ink particles in contact relative to an outer surface of the non-transfer media.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A device comprising:
a media supply to supply a non-transfer media along a travel path and to which a ground element is to be electrically connected;
a first receiving portion along the travel path to receive a fluid ejection device, the fluid ejection device to deliver droplets of ink particles within a dielectric carrier fluid on the non-transfer media to form at least a portion of an image on the media; and
a second portion downstream along the travel path from the first receiving portion and including a charge generation portion to emit airborne charges to charge the ink particles to move, via attraction relative to the grounded media, through the carrier fluid toward the media to become electrostatically fixed on the non-transfer media.

2. The device of claim 1, comprising the fluid ejection device, which comprises a drop-on-demand fluid ejection device to eject the droplets of ink particles within the dielectric carrier fluid to be received on the non-transfer media.

3. The device of claim 1, wherein the fluid ejection device is to eject the dielectric carrier fluid onto the non-transfer media as a non-aqueous fluid.

4. The device of claim 1, comprising:
a first liquid removal portion downstream along the travel path from the second portion to mechanically remove at least a portion of the carrier fluid from the media.

5. The device of claim 4, comprising:
a second liquid removal portion downstream from the first liquid removal portion and including:
a heated air element to direct heated air onto at least one of the carrier fluid and the non-transfer media; or
a radiation device to direct at least one of IR radiation and UV radiation onto the liquid and media.

6. The device of claim 4, comprising:
a finish treatment portion downstream from the first liquid removal portion to apply a finish treatment on the ink particles electrostatically fixed on the media.

7. The device of claim 1, wherein the ground element comprises an electrically conductive element in contact with a portion of the media.

8. The device of claim 1, wherein the media supply is to supply the non-transfer media as a non-absorptive media.

9. A device comprising:
a control portion;
a media supply to supply a flexible, non-transfer media along a travel path and to which a ground element is to be electrically connected; and
a series of stations arranged along the travel path of the non-transfer media in which each station is to provide one color ink of a plurality of different color inks onto the non-transfer media, and wherein each station comprises:
a first portion in which the control portion is to cause a fluid ejection device to deliver droplets of ink particles within a dielectric carrier fluid on the non-transfer media to form at least a portion of an image on the non-transfer media; and
a second portion downstream along the travel path from the first portion and including a charge generation portion to emit airborne charges to charge the ink particles, via attraction relative to the grounded non-transfer media, to move through the carrier fluid toward the non-transfer media to become electrostatically fixed on the non-transfer media.

10. The device of claim 9, wherein each respective station comprises a liquid removal portion including at least one of:
a mechanical removal structure to physically remove carrier fluid on the non-transfer media; and
an energy transfer mechanism to cause evaporation of carrier fluid on the non-transfer media.

11. The device of claim 9, wherein the media supply is to supply the non-transfer media having a white ink layer onto which the ink particles are to be electrostatically fixed.

12. A method comprising:
selectively depositing, via a fluid ejection device, droplets of ink particles within a dielectric carrier fluid onto a non-absorbing, non-transfer media moving along a travel path to form at least a portion of an image;
electrically grounding, via a ground element, the media; and
directing charges onto the ink particles within deposited droplets on the media to induce movement of the charged ink particles, via attraction relative to the grounded media, through the deposited carrier fluid to electrostatically fix the charged ink particles in contact relative to an outer surface of the non-transfer media.

13. The method of claim 12, comprising:
applying a finishing treatment on the electrostatically fixed ink particles on the non-absorbing, non-transfer media.

14. The method of claim 12, comprising:
mechanically removing at least a first portion of the carrier fluid; and
after the mechanical removal, further removing any remaining portion of the carrier fluid via at least one of heated air and radiation.

15. The method of claim 12, comprising:
arranging an outer layer of the non-absorbing, non-transfer media as a metallized foil, wherein the ground element is electrically connected to the metallized foil.
